(19) United States
(12) Patent Application Publication
(10) Pub. No.: US 2008/0171515 A1
(43) Pub. Date: Jul. 17, 2008

(54) APPARATUS AND METHOD FOR ESTIMATING FREQUENCY OFFSET IN WIRELESS COMMUNICATION SYSTEM

(76) Inventors: Sung-Jun KIM, Seoul (KR); Myeon-Kee Youn, Namdong-gu (KR); Seong-Kyu Song, Seoul (KR)

Correspondence Address: THE FARRELL LAW FIRM, P.C., 333 EARLE OVINGTON BOULEVARD, SUITE 701, UNIONDALE, NY, 11553, US

(21) Appl. No.: 11/972,732

(22) Filed: Jan. 11, 2008

(30) Foreign Application Priority Data
Jan. 12, 2007 (KR) 2007-0003588

(51) Int. Cl. H04B 17/00

(52) U.S. Cl. 455/63.1

(57) ABSTRACT

An apparatus and method for estimating frequency offset in a mobile terminal are provided. The method includes collecting information on the locations of a base station and the mobile terminal; calculating a moving speed of the mobile terminal using the collected location information; and estimating the frequency offset using the calculated moving speed.

### PRIORITY

This application claims priority under 35 U.S.C. §119(a) to a Korean Patent Application filed in the Korean Intellectual Property Office on Jan. 12, 2007 and assigned Serial No. 2007-0003588, the contents of which are incorporated herein by reference.

### BACKGROUND OF THE INVENTION

1. Field of the Invention

The present invention relates generally to an apparatus and method for estimating frequency offset in a wireless communication system, and in particular, to an apparatus and method for estimating frequency offset using the information of the locations of a base station and a mobile terminal.

2. Description of the Related Art

In a wireless communication system, a receiver and a transmitter exchange data using a modulation/demodulation level predetermined in a frequency band. In an early wireless communication system, because a receiver communicates with a transmitter while moving at generally low speed in a Line Of Sight (LOS) environment, a frequency offset and a symbol timing offset due to the Doppler shift effect or a multipath channel state insignificantly affect the performance of the receiver. However, recently, a receiver moves at high speed and a high transmission rate and a high communication quality are required, so that the symbol timing offset and the frequency offset significantly affect the performance of the receiver. Thus, extensive research is being conducted to provide a symbol timing offset and a frequency offset that can enhance the performance of the receiver.

Because data signals are transmitted/received over a radio channel in a wireless communication system, multipath fading and the Doppler shift effect degrade the performance of the receiver. The performance degradation due to the multipath fading can be compensated for by using a Rake receiver employing a diversity scheme or a spread spectrum scheme such as a Direct Sequence Spread Spectrum (DSSS) or a Frequency Hopping Spread Spectrum (FHSS) scheme. The FHSS scheme reduces the influence of the multipath fading and a narrow band impulse noise because it transmits data by hopping frequencies using a random sequence. However, it is difficult to achieve the correct synchronization between the transmitter and the receiver.

As wireless communication system users move at high speed according to the increase of vehicles and so on, the mobility of the receiver, i.e., a mobile terminal, increases and thus Doppler shift phenomenon frequently occurs and the degree of the Doppler shift becomes extreme. Therefore, it is important to compensate the frequency offset. Particularly, in an Orthogonal Frequency Division Multiplexing (OFDM) system using a plurality of carrier frequencies [f₀, f₁, . . . , fₙ₋₁] as illustrated in FIGS. 1A and 1B, because high-quality data communication is required even when the mobile terminal moves at a middle speed of 60 km/h, it is very important to provide accurate frequency synchronization.

The frequency offset is closely related to a moving speed of a mobile terminal as shown in Doppler Equation (1):

$${f}_{d} = ( 1 + \frac{v}{c} ) \cdot {f}_{c} , v = {v}_{0} cos θ \qquad ( 1 )$$

where f_{d} is a Doppler frequency, v₀ is a moving speed of a mobile terminal, θ is an angle of a moving direction of the mobile terminal with respect to a base station, c is a source velocity of 3×10⁸ m/s, and f_{c} is a carrier frequency.

Respective carrier frequencies [f₀, f₁, . . . , fₙ₋₁] of an OFDM transmitter shown in FIG. 1A shift to corresponding reception (RX) frequencies [f_{d0}, f_{d1}, . . . , f_{d(n-1)}] of an OFDM receiver shown in FIG. 1B according to the Doppler Equation (1).

Referring to the Doppler Equation (1), as the moving speed v₀ of the mobile terminal increases, the degree of the frequency shift becomes greater, thereby degrading the performance of the mobile terminal. Therefore, there is needed a method for minimizing the frequency offset due to the movement of the mobile terminal.

### SUMMARY OF THE INVENTION

An aspect of the present invention is to substantially solve at least the above problems and/or disadvantages and to provide at least the advantages below. Accordingly, one aspect of the present invention is to provide an apparatus and method for estimating frequency offset in a wireless communication system.

Another aspect of the present invention is to provide an apparatus and method for estimating frequency offset in consideration of a moving speed of a mobile terminal in a wireless communication system.

A further aspect of the present invention is to provide an apparatus and method for estimating frequency offset using the information of the locations of a base station and a mobile terminal in a wireless communication system.

According to an aspect of the present invention, there is provided a method for estimating frequency offset in a mobile terminal. The method includes collecting information on the locations of a base station and the mobile terminal; calculating a moving speed of the mobile terminal using the collected location information; and estimating the frequency offset using the calculated moving speed.

According to another aspect of the present invention, there is provided an apparatus for estimating frequency offset in a mobile terminal. The apparatus includes a Global Positioning System (GPS) module for collecting information on the locations of a base station and the mobile terminal that includes the GPS module; and a frequency offset compensator for calculating a moving speed of the mobile terminal using the collected location information and estimating the frequency offset using the calculated moving speed.

### BRIEF DESCRIPTION OF THE DRAWINGS

The above and other objects, features, and advantages of the present invention will become more apparent from the following detailed description when taken in conjunction with the accompanying drawings in which:

FIGS. 1A and 1B illustrate the structures of a transmitter and a receiver in an OFDM system;

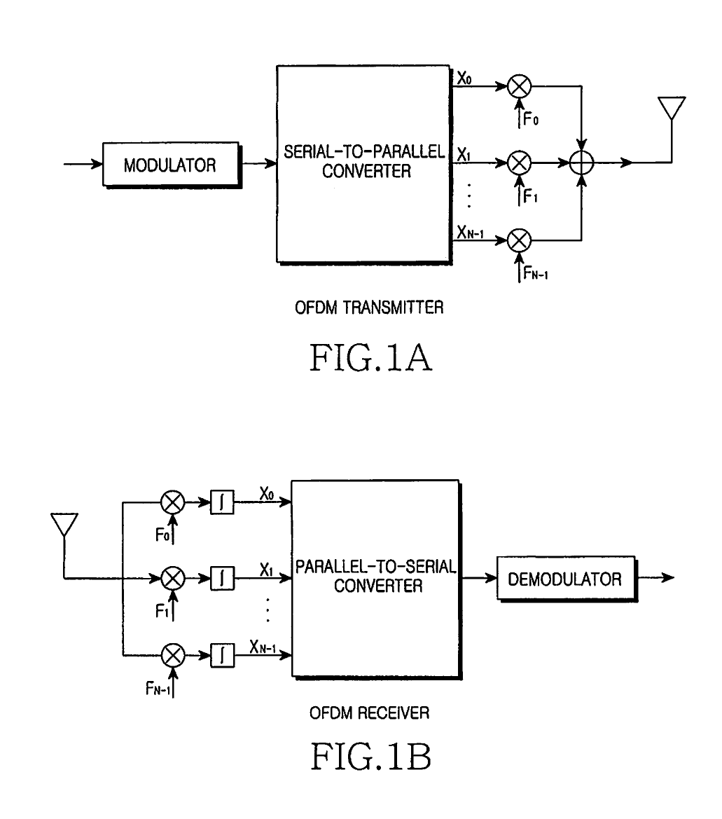

FIG. 2 is a block diagram of a transmitter of a mobile terminal in a wireless communication system according to the present invention;

FIG. 3 is a block diagram of a receiver of a mobile terminal in a wireless communication system according to the present invention;

FIG. 4 is a flowchart illustrating a procedure for estimating frequency offset in a mobile terminal according to the present invention;

FIG. 5 illustrates an example of calculating a moving speed of a mobile terminal according to the present invention;

FIG. 6 illustrates a carrier frequency of a base station and an RX frequency of a mobile terminal in a wireless communication system; and

FIG. 7 illustrates a carrier frequency of a mobile terminal and an RX frequency of a base station in a wireless communication system.

### DETAILED DESCRIPTION OF THE PREFERRED EMBODIMENTS

Preferred embodiments of the present invention will be described herein below with reference to the accompanying drawings. In the following description, well-known functions or constructions are not described in detail because they would obscure the present invention in unnecessary detail.

The present invention provides an apparatus and method for estimating frequency offset based on a moving speed of a mobile terminal that is measured using information on the locations of the mobile terminal and a base station in a wireless communication system.

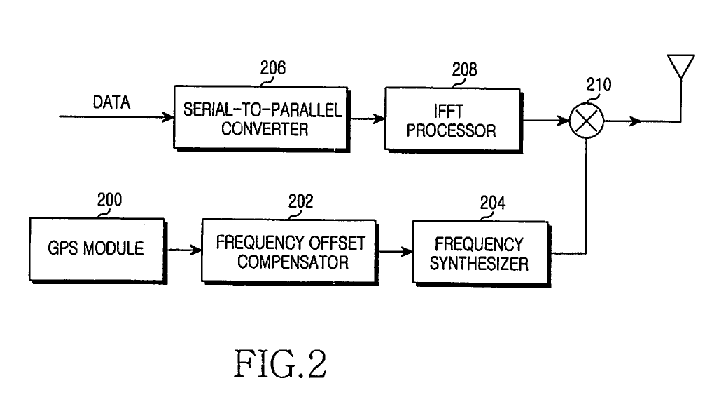

FIG. 2 is a block diagram of a transmitter of a mobile terminal in a wireless communication system according to the present invention. The transmitter of the mobile terminal includes a Global Positioning System (GPS) module 200, a frequency offset compensator 202, a frequency synthesizer 204, a Serial-to-Parallel (S/P) converter 206, an Inverse Fast Fourier Transform (IFFT) processor 208, and a multiplier 210.

In FIG. 2, the GPS module 200 collects information on the locations of a base station and the mobile terminal that includes the Global Positioning System (GPS) module 200 and outputs the location information to the frequency offset compensator 202.

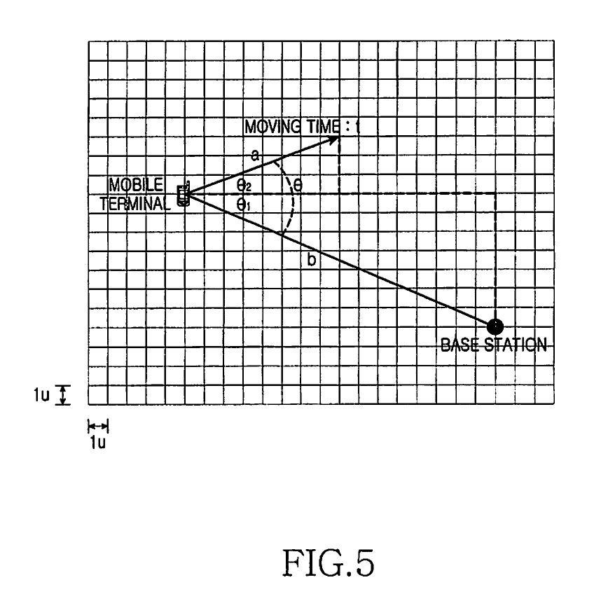

The frequency offset compensator 202 measures a moving direction and a moving distance of the mobile terminal based on the location information, and calculates a moving speed of the mobile terminal using the measured moving distance and moving direction. As illustrated in FIG. 5, the moving distance, the moving direction, and the moving speed of the mobile terminal can be calculated using a coordinate system. Thereafter, the frequency offset compensator 202 estimates frequency offset by substituting the calculated moving speed into Doppler Equation (2) and outputs the estimated frequency offset to the frequency synthesizer 204. Doppler Equation (2) is as follows:

$${f}_{d} = ( 1 + \frac{v}{c} ) \cdot {f}_{c} , v = \frac{a}{t} cos θ \qquad ( 2 )$$

where f_{d} is a Doppler frequency, v is a moving speed of a mobile terminal, c is a source velocity of 3×10⁸ m/s, f_{c} is a carrier frequency, a is a moving distance of the mobile terminal, t is a moving time of the mobile terminal, and θ is an angle of a moving direction of the mobile terminal with respect to a base station.

The frequency synthesizer 204 generates a local oscillator frequency using the estimated frequency offset, produces a center frequency signal of the mobile terminal, and outputs the center frequency signal to the multiplier 210. The frequency synthesizer 204 may use the estimated frequency offset as the local oscillator frequency.

The S/P converter 206 converts serial data into parallel data and outputs the parallel data to the IFFT processor 208. The IFFT processor 208 IFFT-processes the parallel data and outputs the resulting data to the multiplier 210.

The multiplier 210 multiplies the output data of the IFFT processor 208 by the center frequency signal such that the output data is converted into a high frequency signal to be outputted through an antenna.

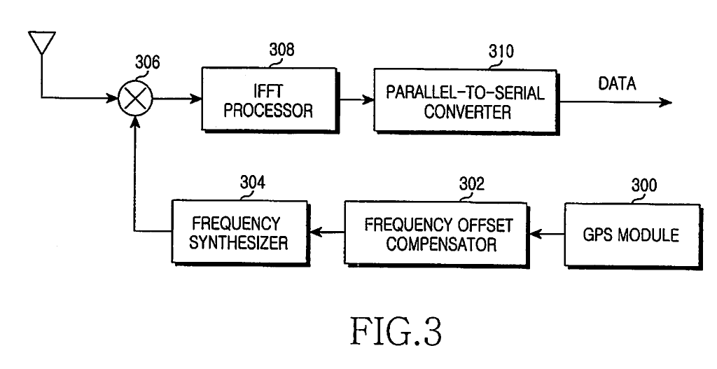

FIG. 3 is a block diagram of a receiver of a mobile terminal in a wireless communication system according to the present invention. The receiver of the mobile terminal includes a GPS module 300, a frequency offset compensator 302, a frequency synthesizer 304, a multiplier 306, a Fast Fourier Transform (FFT) processor 308, and a Parallel-to-Serial (P/S) converter 310.

In FIG. 3, the GPS module 300 collects information on the locations of a base station and the mobile terminal that includes the GPS module 300 and outputs the location information to the frequency offset compensator 302.

The frequency offset compensator 302 measures a moving direction and a moving distance of the mobile terminal based on the location information, and calculates a moving speed of the mobile terminal using the measured moving distance and moving direction. As illustrated in FIG. 5, the moving distance, the moving direction, and the moving speed of the mobile terminal can be calculated using a coordinate system. Thereafter, the frequency offset compensator 302 estimates frequency offset by substituting the calculated moving speed into the above Doppler Equation (2) and outputs the estimated frequency offset to the frequency synthesizer 304.

The frequency synthesizer 304 corrects a local oscillator frequency using the estimated frequency offset, produces a center frequency signal of the mobile terminal, and outputs the center frequency signal to the multiplier 306. The frequency synthesizer 304 may use the estimated frequency offset as the local oscillator frequency.

The multiplier 306 multiplies a signal received through an antenna by the center frequency signal and outputs the resulting data to the FFT processor 308.

The FFT processor 308 FFT-processes the output data of the multiplier 306 and outputs the resulting data to the P/S converter 310. The P/S converter 310 converts the output parallel data of the FFT processor into serial data.

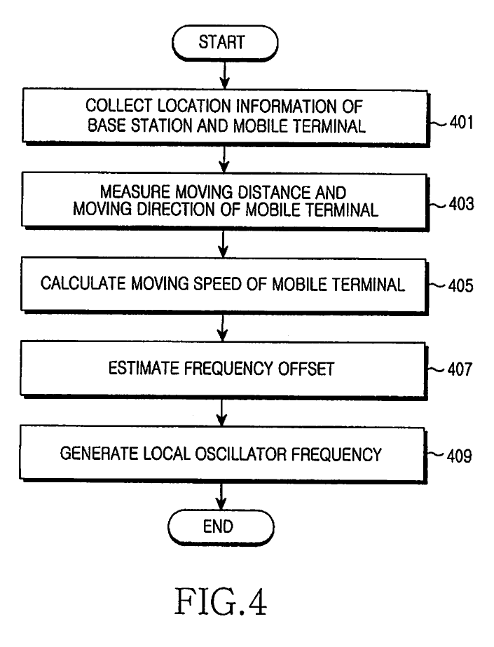

FIG. 4 is a flowchart illustrating a process for estimating frequency offset in a mobile terminal according to one embodiment of the present invention.

In FIG. 4, in step 401, the mobile terminal collects the location information of a base station that communicates with the mobile terminal and its own location information. The location information of the base station may be obtained from a map including the locations of the base stations, while the location information of the mobile terminal may be obtained from a GPS module mounted thereon.

In step 403, a time-dependant moving distance of the mobile terminal and a moving direction of the mobile terminal with respect to the base station are measured using the location information of the base station and the mobile terminal. In step 405, a moving speed of the mobile terminal is calculated using the measured moving distance. In step 407, frequency offset is estimated by calculating the Doppler Equation using the calculated moving speed. The moving speed is calculated using the coordinate system as illustrated in FIG. 5. One graduation in the coordinate system illustrated in FIG. 5 indicates a unit distance. The magnitude of the unit distance is discretionary and determines the accuracy of calculation of the moving speed. Accordingly, as the magnitude decreases, a calculated moving speed can be more accurate. However, as the magnitude decreases, the number of the total coordinates increases, thereby degrading the performance of the mobile terminal due to the increase of memory size and calculation time in the GPS module and the frequency offset compensator.

For example, a moving speed of a mobile terminal is calculated using a coordinate system as follows: as illustrated in FIG. 5, when the mobile terminal is a distance away from a base station and moves a distance in an arrow direction within a time period t, the moving speed of the mobile terminal is v=(a/t) cos θ. Using the coordinate system, a=\sqrt{73}·u , b=\sqrt{305} ·u, and

$$θ = {cos}^{- 1} \frac{16 u}{b} + {cos}^{- 1} \frac{8 u}{a}$$

are calculated (a and b are hypotenuses of right-angled triangle, and therefore can be calculated using a relation of the right-angled triangle). Thereafter, frequency offset is estimated by substituting the obtained v into the Doppler Equation (2).

In step 409, the mobile terminal generates a local oscillator frequency using the estimated frequency offset and then the process is terminated.

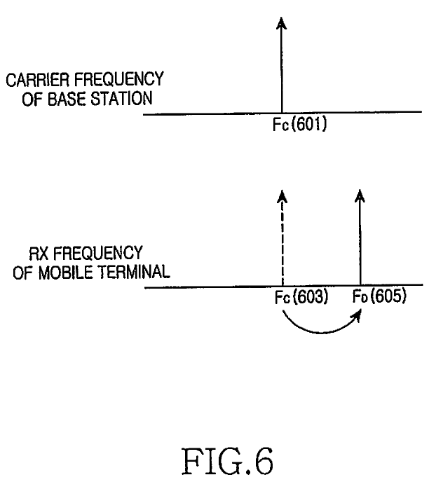

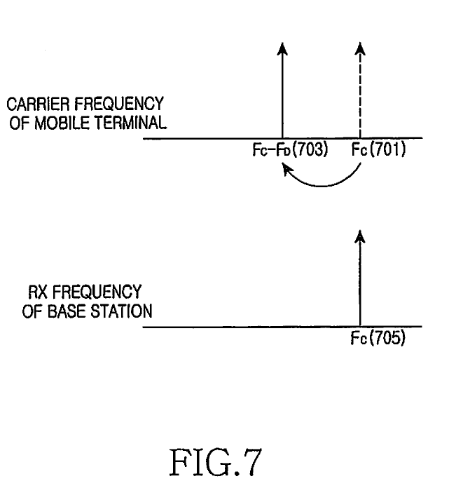

As described above, when the mobile terminal moves at a speed of v in a direction making an angle θ with respect to the base station, a carrier frequency f_{c} 601 transmitted from the base station shifts to a frequency f_{d} 605 through the Doppler Equation (2) as illustrated in FIG. 6. Accordingly, the mobile terminal uses a frequency offset f_{d} 605 estimated in consideration of its moving speed instead of a frequency f_{c} 603 as a local oscillator frequency of the receiver, thereby achieving more accurate frequency synchronization. In addition, when the mobile terminal transmits data signal to the base station while moving at a speed of v in a direction making an angle θ with respect to the base station, an estimated frequency offset is used as a local oscillator frequency in consideration of influence of the Doppler shift effect. That is, as illustrated in FIG. 7, the mobile terminal uses a frequency offset f_{c}−f_{d} 703 instead of a frequency f_{c} 701 as a local oscillator frequency. The frequency offset f_{c}−f_{d} 703 is estimated in consideration of a moving speed of the mobile terminal, and the frequency f_{c} 701 is a local oscillator frequency of the base station. Therefore, an RX frequency of the base station becomes a frequency f_{c} 705 due to the Doppler shift effect.

It will be demonstrated below that when in the mobile terminal a frequency f_{c}−f_{d} is used as a carrier frequency, an RX frequency of the base station becomes f_{c}. If fᵣₓ=f_{c}−f_{d} is substituted into the Doppler Equation (2)

$${f}_{rx} = ( 1 + \frac{v}{c} ) \cdot {f}_{tx} , \qquad$$

the result is

$${f}_{rx} = ( 1 + \frac{v}{c} ) \cdot ( {f}_{c} - {f}_{d} ) = {f}_{c} - \frac{{v}_{0}^{2}}{{c}^{2}} {f}_{c} .$$

Herein, since

$$\frac{{v}_{0}^{2}}{{c}^{2}} {f}_{c} ≅ 0$$

and so fᵣₓ≅f_{c}.

As described above, the mobile terminal calculates its own moving speed using the location information of the base station and its own location information and estimates the frequency offset in consideration of the moving speed, thereby achieving frequency synchronization using the estimated frequency offset even though the moving speed of the mobile terminal increases and improving the receiving ability of the mobile terminal.

Alternate embodiments of the present invention can also comprise computer readable codes on a computer readable medium. The computer readable medium includes any data storage device that can store data that can be read by a computer system. Examples of a computer readable medium include magnetic storage media (such as ROM, floppy disks, and hard disks, among others), optical recording media (such as CD-ROMs or DVDs), and storage mechanisms such as carrier waves (such as transmission through the Internet). The computer readable medium can also be distributed over network coupled computer systems so that the computer readable code is stored and executed in a distributed fashion. Also, functional programs, codes, and code segments for accomplishing the present invention can be construed by programmers of ordinary skill in the art to which the present invention pertains.

While the present invention has been shown and described with reference to certain preferred embodiments thereof, it will be understood by those skilled in the art that various changes in form and details may be made therein without departing from the spirit and scope of the present invention as defined by the appended claims.

What is claimed is:

1. A method for estimating frequency offset in a mobile terminal, the method comprising the steps of:
collecting information on the locations of a base station and the mobile terminal;
calculating a moving speed of the mobile terminal using the collected location information; and
estimating the frequency offset using the calculated moving speed.

2. The method of claim 1, wherein calculating the moving speed further comprises:
measuring a moving direction and a time-dependent moving distance of the mobile terminal using the location information of the base station and the mobile terminal and a coordinate system; and
calculating the moving speed using the measured moving direction and moving distance.

3. The method of claim 1, wherein the moving speed of the mobile terminal is calculated by:
$$v = \frac{a}{t} cos θ$$
where v is a moving speed of a mobile terminal, a is a moving distance of the mobile terminal, t is a moving time of the mobile terminal, and θ is an angle of a moving direction of the mobile terminal with respect to a base station.

4. The method of the claim 1, the frequency offset is estimated by:
$${f}_{d} = ( 1 + \frac{v}{c} ) \cdot {f}_{c}$$
where f_{d} is a Doppler frequency, v is a moving speed of a mobile terminal, c is a source velocity of 3×10⁸ m/s, and f_{c} is a carrier frequency.

5. The method of claim 1, further comprising generating a local oscillator frequency of a transmitter and a receiver of the mobile terminal using the estimated frequency offset.

6. An apparatus for estimating frequency offset in a mobile terminal, the apparatus comprising:
a Global Positioning System (GPS) module for collecting information on the locations of a base station and the mobile terminal that includes the GPS module; and
a frequency offset compensator for calculating a moving speed of the mobile terminal using the collected location information and estimating the frequency offset using the calculated moving speed.

7. The apparatus of claim 6, further comprising a frequency synthesizer for generating a local oscillator frequency of a transmitter and a receiver of the mobile terminal using the frequency offset estimated in the frequency offset compensator.

8. The apparatus of claim 6, wherein the frequency offset compensator measures a moving direction and a time-dependant moving distance of the mobile terminal and calculates a moving speed of the mobile terminal using the measured moving direction and moving distance.

9. The apparatus of claim 6, wherein the moving speed of the mobile terminal is calculated by:
$$v = \frac{a}{t} cos θ$$
where v is a moving speed of a mobile terminal, a is a moving distance of the mobile terminal, t is a moving time of the mobile terminal, and θ is an angle of a moving direction of the mobile terminal with respect to a base station.

10. The apparatus of claim 6, the frequency offset is estimated by:
$${f}_{d} = ( 1 + \frac{v}{c} ) \cdot {f}_{c}$$
where f_{d} is a Doppler frequency, v is a moving speed of a mobile terminal, c is a source velocity of 3×10⁸ m/s, and f_{c} is a carrier frequency.

11. An apparatus for estimating frequency offset in a mobile terminal, the apparatus comprising:
means for collecting information on the locations of a base station and the mobile terminal;
means for calculating a moving speed of the mobile terminal using the collected location information; and
means for estimating the frequency offset using the calculated moving speed.

12. The apparatus of claim 11, wherein the means for calculating the moving speed performs of:
measuring a moving direction and a time-dependent moving distance of the mobile terminal using the location information of the base station and the mobile terminal and a coordinate system; and
calculating the moving speed using the measured moving direction and moving distance.

13. The apparatus of claim 11, wherein the moving speed of the mobile terminal is calculated by:
$$v = \frac{a}{t} cos θ$$
where v is a moving speed of a mobile terminal, a is a moving distance of the mobile terminal, t is a moving time of the mobile terminal, and θ is an angle of a moving direction of the mobile terminal with respect to a base station.

14. The apparatus of the claim 11, the frequency offset is estimated by:
$${f}_{d} = ( 1 + \frac{v}{c} ) \cdot {f}_{c}$$
where f_{d} is a Doppler frequency, v is a moving speed of a mobile terminal, c is a source velocity of 3×10⁸ m/s, and is a carrier frequency.

15. The apparatus of claim 11, further comprising means for generating a local oscillator frequency of a transmitter and a receiver of the mobile terminal using the estimated frequency offset.

16. A computer-readable recording medium having recorded thereon a program for estimating frequency offset in a mobile terminal, comprising:
a first code segment, for collecting information on the locations of a base station and the mobile terminal;
a second code segment, for calculating a moving speed of the mobile terminal using the collected location information; and
a third code segment, for estimating the frequency offset using the calculated moving speed.

17. The computer-readable recording medium of claim 16, further comprising a fourth code segment, for generating a local oscillator frequency of a transmitter and a receiver of the mobile terminal using the estimated frequency offset.
